(19) United States
(12) Patent Application Publication
(10) Pub. No.: US 2006/0134517 A1
(43) Pub. Date: Jun. 22, 2006

(54) Lithium secondary battery

(76) Inventors: Shouichirou Sawa, Itano-gun (JP); Atsushi Fukui, Kobe-shi (JP); Takuya Sunagawa, Naruto-shi (JP); Maruo Kamino, Itano-gun (JP)

Correspondence Address: KUBOVCIK & KUBOVCIK, SUITE 710, 900 17TH STREET NW, WASHINGTON, DC, 20006, US

(21) Appl. No.: 11/300,373

(22) Filed: Dec. 15, 2005

(30) Foreign Application Priority Data
Dec. 17, 2004 (JP) 2004-365390
Aug. 26, 2005 (JP) 2005-245895

(51) Int. Cl. H01M 4/58; H01M 4/48; H01M 10/40; H01M 4/62

(52) U.S. Cl. 429/218.1; 429/231.1; 429/344; 429/232

(57) ABSTRACT

Charge-discharge cycle performance is improved in a lithium secondary battery utilizing a material containing silicon as a positive electrode active material. A lithium secondary battery includes a negative electrode (2) containing silicon as a negative electrode active material, a positive electrode (1) containing a lithium-transition metal composite oxide, and a non-aqueous electrolyte. Lithium carbonate is added in the positive electrode (1), and carbon dioxide is dissolved in the non-aqueous electrolyte.

### BACKGROUND OF THE INVENTION

1. Field of the Invention

The present invention relates to lithium secondary batteries utilizing as a negative electrode active material a material containing silicon.

2. Description of Related Art

In recent years, lithium secondary batteries using a non-aqueous electrolyte and performing charge-discharge operations by transferring lithium ions between positive and negative electrodes have been utilized as a new type of high power, high energy density secondary battery.

Because of their high energy density, lithium secondary batteries have been widely used as power sources for electronic portable devices related to information technology, such as mobile telephones and notebook computers. It has been expected that due to further size reduction and advanced functions of these portable devices, demands for higher energy density in the lithium secondary batteries, used as the device power sources, will be increasingly high.

An effective means to achieve higher energy density in a battery is to use a material having a greater energy density as its active material. Recently, it has been proposed and studied to use an alloy material of an element such as Al, Sn, or Si, that intercalates lithium through an alloying reaction with lithium, as a negative electrode active material having higher energy density in lithium secondary batteries, in place of graphite, which is currently in commercial use.

In the electrode using a material alloyed with lithium as its active material, however, the active material expands and shrinks in volume during the intercalation and deintercalation of lithium, causing the active material to pulverize or peel off from the collector. This leads to the problems of lowering of current collection performance in the electrode and degrading of the battery's charge-discharge cycle performance.

Japanese Published Unexamined Patent Application No. 2004-14472 proposes that in a non-aqueous secondary battery in which its negative electrode active material contains an element or compound that can be alloyed with lithium, such as Si and Sn, carbonate and/or oxalate is contained in the positive electrode, the negative electrode, or the non-aqueous electrolyte to improve charge-discharge cycle performance.

Nevertheless, even with such a technique, the advantageous effect due to the carbonate and/or oxalate cannot be attained sufficiently, and thus the improvement in charge-discharge cycle performance has not been sufficient.

### BRIEF SUMMARY OF THE INVENTION

It is an object of the present invention to provide a lithium secondary battery utilizing silicon as its negative electrode active material, the battery having good charge-discharge cycle performance.

The present invention provides a lithium secondary battery comprising: a negative electrode containing silicon as a negative electrode active material; a positive electrode containing a lithium-transition metal composite oxide as a positive electrode active material; and a non-aqueous electrolyte; wherein lithium carbonate is added to the positive electrode and carbon dioxide is dissolved in the non-aqueous electrolyte.

By adding lithium carbonate in the positive electrode and dissolving carbon dioxide in the non-aqueous electrolyte according to the present invention, good charge-discharge performance is achieved in a lithium secondary battery utilizing a material containing silicon as the negative electrode active material.

### BRIEF DESCRIPTION OF THE DRAWINGS

FIG. 1 is a front view of a lithium secondary battery fabricated according to an example of the present invention;

FIG. 2 is a cross-sectional view taken through A-A of FIG. 1 illustrating the lithium secondary battery fabricated according to an example of the present invention;

FIG. 3 is a SEM micrograph showing a cross section of the positive electrode of Battery A1;

FIG. 4 is a SEM micrograph showing a cross section of the positive electrode of Battery A3; and

FIG. 5 is a different SEM micrograph showing a cross section of the positive electrode of Battery A3.

### DETAILED DESCRIPTION OF THE INVENTION

In the lithium secondary battery according to the present invention, lithium carbonate is added to the positive electrode. This lithium carbonate within the positive electrode decomposes and generates carbon dioxide during charge, that is, when lithium is deintercalated from the positive electrode active material and the potential of the positive electrode is elevated. It is believed that this resultant carbon dioxide serves to cause the lithium intercalation/deintercalation reaction in the negative electrode active material surface, leading to good cycle performance. It is also believed that this advantageous effect of improvement in charge-discharge cycle performance, which is due to the lithium carbonate, can be exhibited further effectively because carbon dioxide is dissolved in the non-aqueous electrolyte.

If lithium carbonate is added in the negative electrode, good cycle performance cannot be obtained because the potential of the negative electrode is low and the above-described advantageous effect due to the lithium carbonate cannot be attained. Moreover, if lithium carbonate exists in the negative electrode mixture layer, the contact area between the negative electrode active material and the negative electrode binder decreases, reducing the strength of the negative electrode mixture layer. Consequently, as charge-discharge operations are repeated, the structure of the electrode is destructed by a change in volume of the negative electrode active material, degrading current collection performance. For this reason, charge-discharge cycle performance degrades.

Meanwhile, if lithium carbonate is added in the non-aqueous electrolyte, the lithium carbonate causes the above-described advantageous effect only in the portion of the non-aqueous electrolyte that is in contact with the positive electrode and not all the lithium carbonate in the battery system works effectively unlike the case in which lithium carbonate is added to the positive electrode. Therefore, charge-discharge cycle performance does not improve sufficiently.

In the present invention, it is preferred that the lithium carbonate added to the positive electrode be contained in the positive electrode in such a manner that it is uniformly mixed with the lithium-transition metal composite oxide. When lithium carbonate is uniformly distributed around the positive electrode active material, the effect of improvement in cycle performance, which is due to the lithium carbonate, can be exhibited more effectively, resulting in better cycle performance.

It is preferred that the amount of the lithium carbonate added to the positive electrode be within the range of from 0.3 weight % to 5 weight % with respect to the lithium-transition metal composite oxide. In other words, it is preferred that 0.3 to 5 parts by weight of lithium carbonate be added in the positive electrode with respect to 100 parts by weight of lithium-transition metal composite oxide. If the amount of lithium carbonate added in the positive electrode is less than 0.3 weight %, the effect of improvement in charge-discharge cycle performance due to the addition of lithium carbonate may not be sufficiently attained. On the other hand, if the amount of lithium carbonate exceeds 5 weight %, the excess lithium carbonate brings about an undesirable side reaction, degrading battery performance.

It is preferred that according to the present invention, lithium carbonate be added to the positive electrode. Adding lithium carbonate to the positive electrode yields better cycle performance than adding lithium carbonate either to the negative electrode or to the non-aqueous electrolyte. This is believed to be because the lithium carbonate contained in the positive electrode works when the potential of the positive electrode increases. In addition, adding lithium carbonate to the positive electrode enables the synergistic effect with the carbon dioxide dissolved in the non-aqueous electrolyte to be exerted more effectively.

It is believed that when the lithium-transition metal composite oxide inevitably contains lithium carbonate, this inevitably-contained lithium carbonate also serves to improve the battery's charge-discharge cycle performance. The lithium carbonate that is inevitably contained in the lithium-transition metal composite oxide means a lithium carbonate originating from the lithium contained in the compound that is reacted with a carbonic acid gas contained in an ambient gas when producing the lithium-transition metal composite oxide, or a portion of the lithium carbonate that has been used as a source material and remains in the resultant product even after the production. It is believed that the lithium carbonate that particularly plays a significant role in the present invention is the one that exists in or near the surface of the lithium-transition metal composite oxide.

When the lithium-transition metal composite oxide inevitably contains lithium carbonate, it is preferred that the total amount of the inevitably-contained lithium carbonate and the lithium carbonate intentionally added in the positive electrode be within the range of from 0.3 weight % to 5 weight % with respect to the lithium-transition metal composite oxide. In other words, it is preferred that the total amount of the lithium carbonates be within the range of from 0.3 to 5 parts by weight with respect to 100 parts by weight of the lithium-transition metal composite oxide. It should be noted that in the present invention, the weight of the lithium-transition metal composite oxide, which serves as the reference for the content of lithium carbonate, does not include the weight of the inevitably-contained lithium carbonate. In other words, the reference weight of the lithium-transition metal composite oxide is: (lithium-transition metal composite oxide)—(lithium carbonate inevitably contained in the lithium-transition metal composite oxide).

When the total amount of the inevitably-contained lithium carbonate and the lithium carbonate added in the positive electrode is less than 0.3 weight %, the effect of improving charge-discharge cycle performance due to the addition of lithium carbonate may not be sufficient. On the other hand, if the total amount exceeds 5 weight %, the excess lithium carbonate may cause a side reaction, degrading battery performance.

The lithium-transition metal composite oxide used in the present invention may be any kind of lithium-transition metal composite oxide as long as it can be used as a positive electrode active material for a lithium secondary battery, and examples include LiCoO₂, LiNiO₂, LiMn₂O₄, LiMnO₂, LiCo_{0.5}Ni_{0.5}O₂, and LiNi_{0.33}CO_{0.33}Mn_{0.34}O₂. Particularly preferred are LiCoO₂ and a layered lithium-transition metal composite oxide containing Ni, Mn, and Co as the transition metals.

It is preferred that in the present invention, the BET specific surface area of the lithium-transition metal composite oxide be 3 m²/g or less. In addition, it is preferred that the lithium-transition metal composite oxide have an average particle size (average particle size of the secondary particles) of 20 μm or less. If the average particle size exceeds 20 μm, the distance over which lithium ions within particles of the lithium-transition metal composite oxide need to travel is so large that the charge-discharge cycle performance tends to degrade.

It is preferred that the positive electrode in the lithium secondary battery of the present invention be such that a positive electrode mixture layer of the lithium-transition metal composite oxide as the positive electrode active material, lithium carbonate, a positive electrode conductive agent, and a positive electrode binder is disposed on a positive electrode current collector made of a conductive metal foil.

The positive electrode binder is not particularly limited as long as it does not dissolve in the solvent of the non-aqueous electrolyte, and preferable examples include fluororesins such as polyvinylidene fluoride, polyimide-based resins, and polyacrylonitriles.

Various known conductive agents may be used as the positive electrode conductive agent; for example, conductive carbon materials may be used. In particular, acetylene black and Ketjen Black may be preferably used.

The conductive metal foil used as the positive electrode current collector may be of any kind as long as it does not dissolve in the electrolyte solution but exists stably at a potential applied to the positive electrode during charging and discharging. A preferable example is an aluminum foil.

It is preferred that the amount of the positive electrode binder in the positive electrode mixture layer be within the range of from 1 weight % to 5 weight % of the positive electrode mixture layer. If the amount of the positive electrode binder is less than 1 weight %, the contact area of the positive electrode powder increases and the contact resistance decreases. However, the excessively small amount of binder will result in poor adherence between active material particles and between the positive electrode active material and the positive electrode current collector, and consequently, the positive electrode active material may easily peel off, leading to poor charge-discharge characteristics. On the other hand, if the amount of the positive electrode binder exceeds 5 weight %, adherence improves between positive electrode active material particles and between the positive electrode active material and the positive electrode current collector. However, because the amount of binder is excessively large, the contact area between positive electrode active material particles becomes too small and the contact resistance increases. Consequently, charge-discharge characteristics may degrade.

It should be noted that the amount of the positive electrode conductive agent in the positive electrode mixture layer should be within the range of from 1 weight % to 5 weight % of the positive electrode mixture layer. If the amount of the positive electrode conductive agent is less than 1 weight %, the amount of conductive agent is so small that a sufficient conductive network may not form around the positive electrode active material and current collection performance may degrade in the positive electrode mixture layer, leading to poor charge-discharge characteristics. On the other hand, if the amount of conductive agent exceeds 5 weight %, the amount of conductive agent is so great that the binder is consumed for bonding the conductive agent, reducing adherence between positive electrode active material particles and adherence between the positive electrode active material and the positive electrode current collector. Consequently, the positive electrode active material may tend to peel off easily, degrading charge-discharge characteristics.

The density of the positive electrode mixture layer in the present invention is preferably 3.0 g/cm³ or greater. When the density of the positive electrode mixture layer is 3.0 g/cm³ or greater, the contact area within the positive electrode active material increases, enhancing the current collection performance in the positive electrode mixture layer and thus yielding good charge-discharge characteristics.

In the positive electrode of the present invention, it is preferred that lithium carbonate be uniformly mixed with and dispersed in the positive electrode active material, as mentioned above. The positive electrode active material and the lithium carbonate may be uniformly mixed and dispersed together in the following manner, for example. Powder of a positive electrode active material, powder of lithium carbonate, and powder of a positive electrode conductive agent may be uniformly mixed and dispersed in a solution of a positive electrode binder to prepare a positive electrode mixture slurry. The resultant positive electrode mixture slurry is applied onto a positive electrode current collector and is then dried to form a positive electrode mixture layer.

It is preferred that the positive electrode active material be kept in a state in which secondary particles are formed, even in the positive electrode mixture slurry. Therefore, the positive electrode mixture slurry is preferably prepared in the following manner. First, only the powder of lithium carbonate and the powder of positive electrode conductive agent are mixed and dispersed uniformly in the solution of the positive electrode binder, and thereafter the positive electrode active material is added therein and mixed with a force such that the secondary particles of the positive electrode active material do not break.

It is preferred that lithium carbonate powder be mixed and dispersed uniformly in the binder solution before the positive electrode active material is added and mixed. Because lithium carbonate powder easily aggregates and forms secondary particles, it is preferable to use an agitation mixer or a dispersion machine, such as a mortar, a mixer, a homogenizer, a dissolver, a kneader, a roll mill, a sand mill, a ball mill, and the like.

Examples of the solvent for the non-aqueous electrolyte used in the present invention include, but are not particularly limited to: cyclic carbonates such as ethylene carbonate, propylene carbonate, butylene carbonate, and vinylene carbonate; chain carbonates such as dimethyl carbonate, methyl ethyl carbonate, and diethyl carbonate; esters such as methyl acetate, ethyl acetate, propyl acetate, methyl propionate, ethyl propionate, and γ-butyrolactone; ethers such as 1,2-dimethoxyethane, 1,2-diethoxyethane, tetrahydrofuran, 1,2-dioxane, and 2-methyltetrahydrofuran; nitrites such as acetonitrile; and amides such as dimethylformamide. These solvents may be used either alone of in combination. Particularly preferred is a mixed solvent of a cyclic carbonate and a chain carbonate.

Examples of the solute of the non-aqueous electrolyte in the present invention include, but are not particularly limited to: lithium compounds represented by the chemical formula LiXF_{y} (wherein X is P, As, Sb, B, Bi, Al, Ga, or In; and y is 6 when X is P, As, or Sb; or y is 4 when X is B, Bi, Al, Ga, or In), such as LiPF₆, LiBF₄, LiAsF₆; and lithium compounds such as LiCF₃SO₃, LiN (CF₃SO₂)₂, LiN (C₂F₅SO₂)₂, LiN (CF₃SO₂) (C₄F₉SO₂), LiC (CF₃SO₂)₃, LiC(C₂F₅SO₂)₃, LiClO₄, Li₂B₁₀Cl₁₀, and Li₂B₁₂Cl₁₂. Among these, LiPF₆ is particularly preferable.

Examples of the electrolyte include a gelled polymer electrolyte in which an electrolyte solution is impregnated in a polymer electrolyte made of polyethylene oxide, polyacrylonitrile, or the like, and inorganic solid electrolytes such as LiI or Li₃N. There is no limitation to the electrolyte of the lithium secondary battery of the present invention, and any solute may be used as long as the lithium compound as the solute for providing ionic conductivity and the solvent for dissolving and retaining the solute do not decompose at a voltage of charging and discharging operations, or at a voltage during storage of the battery.

Carbon dioxide is dissolved in the non-aqueous electrolyte in the present invention. By allowing carbon dioxide to dissolve in the non-aqueous electrolyte, the synergistic effect with the lithium carbonate added to the positive electrode is exerted, and the lithium intercalation/deintercalation reaction is caused on the surface of lithium-transition metal composite oxide smoothly, making it possible to attain good cycle performance. It is believed that because a surface film originating from carbon dioxide is formed on the surface of silicon, which is the negative electrode active material, the lithium intercalation/deintercalation reaction occurs smoothly on the surface of the negative electrode active material.

The amount of carbon dioxide to be dissolved is preferably 0.01 weight % or greater, more preferably 0.05 weight % or greater, and still more preferably 0.1 weight % or greater. The upper limit is not particularly set, and the saturation amount of carbon dioxide dissolved is the upper limit value.

The amount of the lithium carbonate contained in the positive electrode can be obtained by dissolving the binder with a solvent, thereafter extracting lithium carbonate with water, and subjecting the lithium carbonate contained in the aqueous extract to neutralization titration with hydrochloric acid or the like. Such a method makes it possible to measure the total amount of the lithium carbonate inevitably contained in the lithium-transition metal composite oxide and the lithium carbonate added in the positive electrode.

It is preferred that the negative electrode in the present invention is such that a negative electrode mixture layer including a binder and active material particles containing silicon and/or silicon alloy is disposed on a negative electrode current collector made of a conductive metal foil. Examples of the silicon alloy include solid solutions made of silicon and one or more other elements, intermetallic compounds made of silicon and one or more other elements, and eutectic alloys made of silicon and one or more other elements. Examples of the method for producing the alloy include arc melting, liquid quenching, mechanical alloying, sputtering, chemical vapor deposition, and baking. Specifically, examples of the liquid quenching include a single-roll quenching technique, a double-roller quenching technique, and various atomization techniques such as gas atomization, water atomization, and disk atomization.

The negative electrode active material used in the present invention may be one in which surfaces of particles of silicon and/or silicon alloy are coated with metal or the like. Examples of the method of coating include electroless plating, electroplating, chemical reduction techniques, evaporation, sputtering, and chemical vapor deposition.

In the present invention, particles made of silicon alone are the most preferable as the negative electrode active material.

Although not particularly limited, the average particle size of the negative electrode active material in the present invention is preferably 100 μm or less, more preferably 50 μm or less, and most preferably 10 μm or less. Using active material particles having a small particle size serves to reduce the absolute magnitude of the expansion and shrinkage in volume of the active material particles that are associated with lithium intercalation and deintercalation during charging and discharging. This accordingly reduces the absolute magnitude of the strain between the active material particles in the electrode during charging and discharging, making destruction of the binder less likely to occur. Thus, it becomes possible to prevent the current collection performance in the electrode from degrading and to attain good charge-discharge cycle performance.

It is preferred that the particle size distribution of the negative electrode active material in the present invention be as narrow as possible. If the particle size distribution is wide, great differences in the absolute magnitude of expansion and shrinkage in volume associated with lithium intercalation and deintercalation will exist among the active material particles. Therefore, strain will occur within the mixture layer, leading to destruction of the layer. Consequently, current collection performance in the electrode lowers, degrading the charge-discharge cycle performance.

The advantageous effect originating from the lithium carbonate added in the positive electrode is exhibited more effectively when using negative electrode active material powder that has a small particle size and a narrow particle size distribution. That is, the lithium carbonate in the positive electrode allows the lithium intercalation/deintercalation reaction on the surface of the negative electrode active material to occur appropriately, significantly improving uniformity in the distribution of a charge-discharge reaction in the negative electrode. Thus, it is possible to reduce the strain in the active material that is produced by the imbalance in the change in volume of the active material and prevent the active material particles from cracking or the like, and therefore, the charge-discharge cycle performance improves greatly.

In the negative electrode current collector of the present invention, it is preferred that a surface on which the negative electrode mixture layer is to be disposed have a surface roughness Ra of 0.2 μm or greater. When using a conductive metal foil having such a surface roughness Ra as the negative electrode current collector, the binder gets into the portions of the current collector surface in which the surface irregularities exist, thereby to exert an anchoring effect and provide strong adherence between the binder and the current collector. As a result, it is possible to substantially prevent the peeling off of the mixture layer from the current collector, which is due to the expansion and shrinkage in volume of the active material particles that are associated with the lithium intercalation and deintercalation. Where both sides of the current collector are provided with the negative electrode mixture layer, it is preferred that the surface roughness Ra be 0.2 μm or greater on both sides of the negative electrode.

It is preferred that surface roughness Ra and mean spacing of local peaks S have a relationship 100Ra≧S. Surface roughness Ra and mean spacing of local peaks S are defined in Japanese Industrial Standards (JIS B 0601-1994) and can be measured by, for example, a surface roughness meter.

To provide the current collector with a surface roughness Ra of 0.2 μm or greater, the conductive metal foil may be subjected to a roughening process. Examples of the roughening process include plating, vapor deposition, etching, and polishing. The plating and the vapor deposition are techniques in which a surface of the metal foil is roughened by forming a thin film layer having irregularities on the metal foil surface. Examples of the plating include electroplating and electroless plating. Examples of the vapor deposition include sputtering, chemical vapor deposition, and evaporation. Examples of the etching include such techniques as physical etching and chemical etching. Examples of the polishing include polishing by sandpaper and polishing by blasting.

The current collector in the present invention may be made of a foil of a metal such as copper, nickel, iron, titanium, or cobalt, or may be an alloy foil formed of a combination thereof.

It is particularly preferred that the negative electrode current collector in the present invention have a high mechanical strength. When the current collector has a high mechanical strength, the current collector does not suffer destruction or plastic deformation even if the current collector undergoes a stress that occurs due to the change in volume of the negative electrode active material at the time of lithium intercalation and deintercalation. As a result, the mixture layer is prevented from peeling off from the current collector, the current collection performance in the electrode is maintained, and good cycle performance is attained.

Although not particularly limited, the thickness of the negative electrode current collector in the present invention is preferably within the range of from 10 μm to 100 μm.

The upper limit of the surface roughness Ra of the negative electrode current collector in the present invention is not particularly limited; however, because it is preferred, as mentioned above, that the thickness of the conductive metal foil be within the range of from 10 μm to 100 μm, the upper limit of the surface roughness Ra is practically 10 μm or less.

In the negative electrode of the present invention, it is preferred that the thickness of the negative electrode mixture layer X have relationships with current collector thickness Y and surface roughness Ra represented by 5Y≧X and 250Ra≧X, respectively. If the mixture layer thickness X is greater than 5Y or greater than 250Ra, the expansion and shrinkage in volume of the mixture layer during charging and discharging are so great that the adherence between the mixture layer and the current collector cannot be maintained by the irregularities on the current collector surface, causing the mixture layer to peel off from the current collector.

Although not particularly limited, the thickness of the negative electrode mixture layer X in the present invention is preferably 1000 μm or less, and more preferably from 10 μm to 100 μm.

It is preferred that the negative electrode binder in the present invention have a high mechanical strength and good elasticity. When the binder has good mechanical properties, the binder does not suffer destruction and the mixture layer can deform according to a change in volume of the active material, even if a change in volume of the negative electrode active material occurs in the lithium intercalation and deintercalation. As a consequence, the current collection performance in the electrode is maintained, and outstanding cycle performance is obtained. Such a binder having good mechanical properties may be a polyimide resin. In addition, fluoropolymers such as polyvinylidene fluoride and polytetrafluoroethylene may also be suitably used.

In the present invention, it is preferred that the amount of the negative electrode binder be 5 weight % or greater of the total weight of the negative electrode mixture layer, and the volume occupied by the binder be 5% or greater of the total volume of the negative electrode mixture layer. Herein, the total volume of the negative electrode mixture layer is intended to mean the total of the volumes of the materials contained in the mixture layer, such as the active material and the binder, and it does not include the volume of voids in the mixture layer in the case where voids exist in the mixture layer. If the amount of binder is less than 5 weight % of the total weight of the mixture layer and the volume occupied by the binder is less than 5% of the total volume of the mixture layer, the amount of the binder is so small with respect to the negative electrode active material that the adherence of the binder becomes insufficient in the electrode. On the other hand, if the amount of the binder is too large, the resistance in the electrode increases, making the initial charging difficult. For these reasons, it is preferred that the amount of the negative electrode binder be 50 weight % or less of the total weight of the negative electrode mixture layer and the volume occupied by the binder be 50% or less of the total volume of the negative electrode mixture layer.

In the negative electrode of the present invention, conductive powder may be mixed in the mixture layer. By mixing conductive powder in the mixture layer, a conductive network originating from the conductive powder can form around the active material particles, further improving the current collection performance within the electrode. For the conductive powder, the same kinds of materials as those for the conductive metal foil may be suitably used. Specifically, suitable materials include metals such as copper, nickel, iron, titanium, and cobalt, as well as alloys and mixtures thereof. In particular, copper powder is used suitably as a metal powder. In addition, conductive carbon powder may be suitably used.

It is preferred that the amount of the conductive powder to be mixed within the negative electrode mixture layer be 50 weight % or less of the total weight of the negative electrode active material, and the volume occupied by the conductive powder be 20% or less of the total volume of the negative electrode mixture layer. If the amount of the conductive powder mixed is too large, the relative proportion of the negative electrode active material in the negative electrode mixture layer reduces correspondingly and consequently the charge-discharge capacity of the negative electrode becomes small. Moreover, in this case, the proportion of the amount of the binder reduces with respect to the total amount of the active material and the conductive agent in the mixture layer, and therefore, the strength of the mixture layer reduces, degrading the charge-discharge cycle performance.

Although not particularly limited, the average particle size of the conductive powder is preferably 100 μm or less, more preferably 50 μm or less, and most preferably 10 μm or less.

It is further preferred that the negative electrode in the present invention be such that a negative electrode mixture layer including a negative electrode binder and particles containing silicon and/or silicon alloy, which serve as a negative electrode active material, is sintered and disposed on a surface of a conductive metal foil as a negative electrode current collector. When the mixture layer is disposed on the current collector surface by sintering, adherence between active material particles and adherence between the mixture layer and the current collector improve greatly due to the effect of the sintering. Therefore, even if a change in volume of the negative electrode active material occurs at the time of lithium intercalation and deintercalation, it is possible to maintain the current collection performance of the mixture layer and to attain good charge-discharge cycle performance.

It is particularly preferred that the negative electrode binder be thermoplastic. For example, when the negative electrode binder has a glass transition temperature, it is desirable to carry out heating for sintering and disposing the negative electrode mixture layer on the negative electrode current collector surface at a temperature higher than the glass transition temperature. This causes the binder to thermally bond with the active material particles and the current collector, greatly improving adherence between the active material particles and between the mixture layer and the current collector; consequently, the current collection performance within the electrode can be improved greatly, and further excellent cycle performance can be attained.

Further in this case, it is preferred that the negative electrode binder remain without being decomposed completely even after the heating process. If the binder is completely decomposed after the heating process, the bonding effect owing to the binder is lost, and therefore, the current collection performance of the electrode greatly lowers, degrading the charge-discharge cycle performance.

The sintering for disposing the negative electrode mixture layer on the current collector surface should preferably be performed in a nitrogen atmosphere or in an inert gas atmosphere such as argon. Alternatively, the sintering may be performed in a reducing atmosphere such as a hydrogen atmosphere. The heating temperature in the sintering should preferably be equal to or less than the temperature at which the binder resin starts to thermally decompose, because it is preferred that the negative electrode binder remain without being decomposed completely even after the heating process for sintering. The usable methods of the sintering include discharge plasma sintering and hot pressing.

In the present invention, it is preferred that the negative electrode be fabricated by uniformly mixing and dispersing particles containing silicon and/or silicon alloy, which serve as a negative electrode active material, in a solution of a negative electrode binder to produce a negative electrode mixture slurry, and applying the resultant negative electrode mixture slurry onto a surface of a conductive metal foil as a negative electrode current collector. The mixture layer thus produced using a slurry in which the active material particles are uniformly mixed and dispersed in a binder solution forms a structure in which the binder is uniformly distributed around each of the active material particles; therefore, it becomes possible to obtain maximum benefit from the mechanical properties of the binder, to attain high electrode strength, and to obtain good charge-discharge cycle performance.

### DESCRIPTION OF PREFERRED EMBODIMENTS

Hereinbelow, the present invention is described in further detail based on examples thereof. It should be construed, however, that the present invention is not limited to the following examples, and various changes and modifications are possible without departing from the scope of the invention.

Experiment 1

Preparation of Positive Electrode

500 g of a 6 weight % N-methyl-pyrrolidone solution of polyvinylidene fluoride, 30 g of acetylene black, and 1.8 kg of 1.5-mm diameter beads made of ZrO₂ were filled in a Al₂O₃ container with a 2 liter capacity of a bead mill and agitated by rotating a disk-shaped Al₂O₃ agitating blade at 1500 rpm for 15 minutes, and thereafter all the ZrO₂ beads were removed. Thus, a positive electrode paste was obtained in which acetylene black powder was uniformly mixed and dispersed in the N-methyl-pyrrolidone solution of polyvinylidene fluoride.

Next, Li₂CO₃ and CoCO₃ were mixed in a mortar so that the mole ratio of Li and Co became 1:1. The mixture was sintered in an air atmosphere at 800° C. for 24 hours and thereafter pulverized to obtain a lithium-cobalt composite oxide represented as LiCoO₂ and having an average particle size of about 7 μm. The BET specific surface area of the resultant LiCoO₂ was 0.47 m²/g.

The LiCoO₂ powder as the positive electrode active material, the above-mentioned positive electrode paste, and lithium carbonate powder having an average particle size of 50 μm were mixed at a weight ratio of 94:53:3, and the mixture was agitated using a Robomics made by Tokushu Kika Kogyo Co., Ltd. by rotating the agitating blade at 3000 rpm for 30 minutes. Thus, a positive electrode mixture slurry was obtained in which LiCoO₂ powder, polyvihylidene fluoride, acetylene black, and lithium carbonate powder were mixed at a weight ratio of 94:3:3:3 in the N-methyl-pyrrolidone solution of polyvinylidene fluoride.

The resultant positive electrode mixture slurry was applied onto one side of an aluminum foil (thickness 15 μm) serving as a positive electrode current collector and then dried, and thereafter, the resultant material was pressure-rolled. The resultant article was cut out into a 20 mm×20 mm square shape, and a current collector tab was attached thereto. Thus, a positive electrode was prepared.

Preparation of Negative Electrode

Silicon powder (purity: 99.9%) having an average particle size of 3 μm, which serves as a negative electrode active material, and thermoplastic polyimide having a glass transition temperature of 190° C. and a density of 1.1 g/cm³, which serves as a negative electrode binder, were mixed together with N-methyl-2-pyrrolidone as a dispersion medium so that the weight ratio of the active material to the binder became 90:10, to thus prepare a negative electrode mixture slurry.

The resultant negative electrode mixture slurry was applied onto one side of (a roughened surface of) an electrolytic copper foil (thickness 35 μm) having a surface roughness Ra of 1.0 μm, which was a negative electrode current collector, and then dried. The resultant article was cut out into a 25 mm×30 mm rectangle shape, then pressure-rolled, and thereafter sintered by heating at 400° C. for 1 hour under an argon atmosphere, to thus prepare a negative electrode.

Preparation of Electrolyte Solution

LiPF₆ was dissolved at a concentration of 1 mole/liter into a mixed solvent of 3:7 volume ratio of ethylene carbonate and diethyl carbonate. Carbon dioxide was blown into the resultant solution to dissolve carbon dioxide in the solution, to thus prepare an electrolyte solution. The amount of carbon dioxide dissolved in the electrolyte solution was determined by a gravimetric method (weight after dissolving carbon dioxide—weight before dissolving carbon dioxide), and consequently, the amount of carbon dioxide dissolved was found to be 0.37 weight % with respect to the total weight of the electrolyte solution.

Preparation of Battery

A lithium secondary battery A1 was prepared, in which the positive electrode, the negative electrode, and the electrolyte solution that were prepared as described above were inserted in a battery case made of an aluminum laminate.

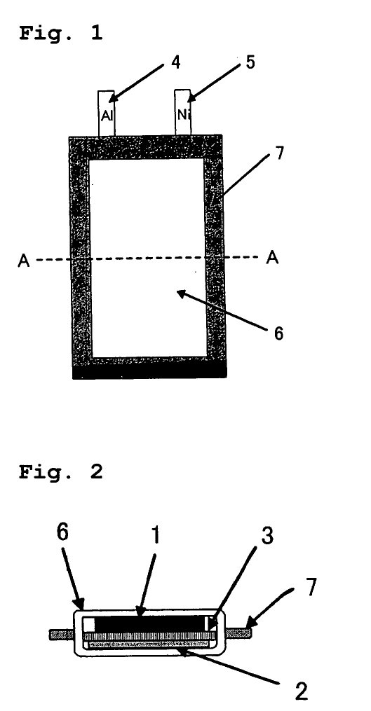

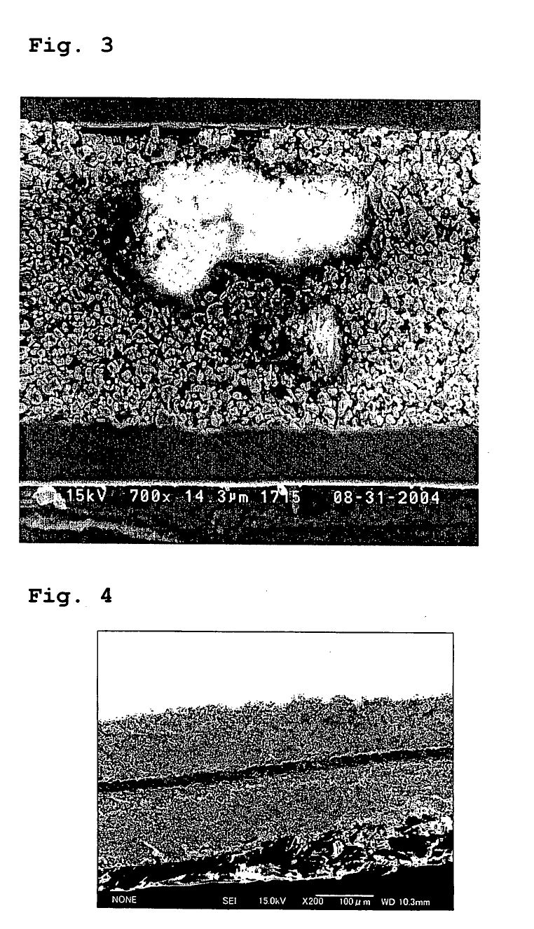

As illustrated in FIGS. 1 and 2, a positive electrode 1 and a negative electrode 2 oppose each other across a separator 3 made of porous polyethylene, and are respectively connected to a positive electrode tab 4 and a negative electrode tab 5, to thus form a structure by which charging and discharging are possible as a secondary battery.

The prepared lithium secondary battery A1 comprised a battery case 6 made of an aluminum laminate, a sealed part 7 at which two ends of the aluminum laminate were heat sealed, a positive electrode current collector tab 4, a negative electrode current collector tab 5, and an electrode assembly in which the separator 3 was sandwiched between the positive electrode 1 and the negative electrode 2.

Experiment 2

Battery B1 was fabricated in the same manner as in Experiment 1 except that lithium carbonate powder was not added in preparing the positive electrode as in Experiment 1.

Experiment 3

Batteries B2 and B3 were fabricated in the same manners as in fabricating Batteries A1 and B1, respectively, except that carbon dioxide was not dissolved in preparing the electrolyte solutions as in Batteries A1 and B1.

Experiment 4

In preparing positive electrodes as in Batteries A1 and B1 to B3, LiOH and a coprecipitated hydroxide represented by the formula Ni_{0.4}Mn_{0.3}Co_{0.3}(OH)₂ were mixed in a mortar so that the mole ratio of Li and the total of the transition metals became 1:1, and the resultant mixture was sintered at 1000° C. for 20 hours in an air atmosphere and thereafter pulverized to obtain a lithium-transition metal composite oxide represented by the formula LiNi_{0.4}Mn_{0.3}Co_{0.3}O₂ and having an average particle size of about 10 μm. Batteries A2 and B4 to B6 were fabricated in the same manners as in the respective fabrication methods of Batteries A1 and B1 to B3, except that the lithium-transition metal composite oxide was used as the positive electrode active material. The BET specific surface area of LiNi_{0.4}Mn_{0.3}CO_{0.3}O₂ used here was 1.04 m²/g.

Evaluation of Charge-Discharge Cycle Performance

Batteries A1, A2, and B1 to B6 were evaluated in terms of the charge-discharge cycle performance. Each battery was charged at 25° C. with a current of 14 mA to 4.2 V, then charged at 4.2 V until a current of 0.7 mA was reached, and thereafter discharged with a current of 14 mA to 2.75 V. This process was taken as 1 charge-discharge cycle. The charge-discharge cycle was repeated to determine the number of cycles until the discharge capacity of each battery reached 80% of the discharge capacity at the first cycle, and the number of cycles thus obtained was taken as the cycle life of the battery. The results are shown in Table 1. It should be noted that the cycle life values of the batteries are indicated by relative indices wherein the cycle life of Battery A1 is taken as 100.

TABLE 1

| | | Lithium | Carbon | |
|---|---|---|---|---|
| | | carbonate | dioxide | |
| | Positive | added in | dissolved in | |
| | electrode | positive | electrolyte | Cycle |
| Battery | active material | electrode | solution | life |
| A1 | LiCoO₂ | Yes | Yes | 100 |
| B1 | LiCoO₂ | No | Yes | 58 |
| B2 | LiCoO₂ | Yes | No | 50 |
| B3 | LiCoO₂ | No | No | 49 |
| A2 | LiNi_{0.4}Mn_{0.3}Co_{0.3}O₂ | Yes | Yes | 115 |
| B4 | LiNi_{0.4}Mn_{0.3}Co_{0.3}O₂ | No | Yes | 73 |
| B5 | LiNi_{0.4}Mn_{0.3}Co_{0.3}O₂ | Yes | No | 64 |
| B6 | LiNi_{0.4}Mn_{0.3}Co_{0.3}O₂ | No | No | 64 |

Table 1 clearly shows that Batteries A1 and A2, in which lithium carbonate was added in the positive electrodes and moreover carbon dioxide was dissolved in the electrolyte solutions, showed better cycle performance than Batteries B1 and B4, in which carbon dioxide was dissolved in the electrolyte solutions but lithium carbonate was not added to the positive electrodes, and than Batteries B2 and B5, in which lithium carbonate was added in the positive electrodes but carbon dioxide was not dissolved in the electrolyte solutions. This is believed to be because, with the batteries utilizing silicon as the negative electrode active material, the effect of improving charge-discharge cycle performance originating from the lithium carbonate added in the positive electrode became more effective because carbon dioxide was dissolved in the electrolyte solution.

Next, a study was conducted about how the distribution and content of lithium carbonate in the positive electrode affect the charge-discharge cycle performance of batteries.

Experiment 5

Preparation of Positive Electrode

500 g of 6 weight % N-methyl-pyrrolidone solution of polyvinylidene fluoride, 30 g of acetylene black, 30 g of lithium carbonate powder having an average particle size of 50 μm, and 1.8 kg of 1.5-mm diameter beads made of ZrO₂ were filled in a Al₂O₃ container with a 2 liter capacity of a bead mill, and agitated by rotating a disk-shaped Al₂O₃ agitating blade at 1500 rpm for 15 minutes, and thereafter all the ZrO₂ beads were removed. Thus, a positive electrode paste was obtained in which acetylene black powder and lithium carbonate powder were uniformly mixed and dispersed in the N-methyl-pyrrolidone solution of polyvinylidene fluoride.

The same LiCoO₂ powder as used in Battery Al and the foregoing positive electrode paste were mixed at a weight ratio of 94:56, and the mixture was agitated using a Robomics made by Tokushu Kika Kogyo Co., Ltd. by rotating the agitating blade at 3000 rpm for 30 minutes. Thus, a positive electrode mixture slurry was obtained in which LiCoO₂ powder, polyvinylidene fluoride, acetylene black, and lithium carbonate powder were mixed at a weight ratio of 94:3:3:3 in the N-methyl-pyrrolidone solution of polyvinylidene fluoride.

The resultant positive electrode mixture slurry was applied onto one side of an aluminum foil (thickness 15 μm) serving as a positive electrode current collector and then dried, and thereafter, the resultant material was pressure-rolled. The resultant article was cut out into a 20 mm×20 mm square shape, and a current collector tab was attached thereto. Thus, a positive electrode was prepared.

Preparation of Battery

Battery A3 was fabricated in the same manner as in the fabrication method of Battery A1 except that the positive electrode prepared in the foregoing manner was used as the positive electrode.

Experiment 6

As in preparing the positive electrode of Battery A3, positive electrode pastes were prepared by setting the amounts of lithium carbonate powder added to be 2 g, 4 g, 45 g, and 50 g, respectively. Then, the positive electrode active material powder and these pastes were mixed together at respective weight ratios of [94:53.2], [94:53.4], [94:57.5], and [94:58]. Thus, positive electrode mixture slurries were obtained in which the positive electrode active material powder, polyvinylidene fluoride, carbon material powder, and lithium carbonate powder were uniformly mixed and dispersed in N-methyl-pyrrolidone solution of polyvinylidene fluoride so that the weight ratios became [94:3:3:0.2], [94:3:3:0.4], [94:3:3:4.5], and [94:3:3:5], respectively. Batteries A4 to A7 were fabricated in the same manners as in the fabrication method of Battery A3 except that the just-noted positive electrode mixture slurries were used.

Experiment 7

Batteries A8 to A12 were fabricated in the same manners as the fabrication methods of Batteries A3 to A7 except that LiNi_{0.4}Mn_{0.3}Co_{0.3}O₂, which was the same as in Batteries A2 and B4 to B6, was used as the positive electrode active material when preparing the positive electrodes as in Batteries A3 to A7.

Experiment 8

As in preparing the positive electrode of Battery A3, LiOH and Ni_{0.4}Mn_{0.3}Co_{0.3}(OH)₂ were mixed in a mortar so that the mole ratio of Li to the total of the transition metals became 1.02:1. Thereafter, the mixture was sintered at 1000° C. for 20 hours in an air atmosphere and thereafter pulverized, to thus obtain a lithium-transition metal composite oxide represented as Li_{1.02}Ni_{0.4}Mn_{0.3}Co_{0.3}O₂ and having an average particle size of about 10 μm. Battery A13 was fabricated in the same manner as the fabrication method of Battery A3 except that the resultant lithium-transition metal composite oxide was used as the positive electrode active material. Li_{1.02}Ni_{0.4}Mn_{0.3}Co_{0.3}O₂ used in Battery A13 had a BET specific surface area of 1.01 m²/g.

Evaluation of Charge-Discharge Cycle Performance

Batteries A3 to A13 were evaluated in terms of the charge-discharge cycle performance in the same manner as for Battery A1. The results are shown in Table 2. It should be noted that the cycle life values are indicated by relative indices wherein the cycle life of Battery A1 is taken as 100.

Measurement of Amount of Lithium Carbonate in the Positive Electrode Active Material

With the lithium-transition metal composite oxides used as the positive electrode active materials in the foregoing Batteries A1 to A13, respective amounts of lithium carbonate inevitably contained in the lithium-transition metal composite oxides were determined according to the following method.

Each of the lithium-transition metal composite oxides was dispersed in pure water and subjected to untrasonication for 10 minutes, and thereafter, the lithium-transition metal composite oxide powder was removed by filtering the resultant solution to obtain a filtrate. The filtrate thus obtained was titrated with 0.1N HCl aqueous solution, whereby the amount of lithium carbonate inevitably contained in the lithium-transition metal composite oxide was determined. The results are shown as “Amount of lithium carbonate in positive electrode active material” in Table 2 below.

Table 2 shows the just-noted “Amounts of lithium carbonate in positive electrode active material”, amounts of lithium carbonate added to positive electrode (“Amount of lithium carbonate powder added”), and their total amounts (“Total amount of lithium carbonate in positive electrode”).

TABLE 2

| | | Amount of lithium | Amount of | Total amount of | Method of | |
|---|---|---|---|---|---|---|
| | | carbonate in | lithium | lithium carbonate | adding | |
| | Positive | positive electrode | carbonate | in positive | lithium | |
| | electrode active | active material | powder added | electrode | carbonate | Cycle |
| Battery | material | (wt. %) | (wt. %) | (wt. %) | powder | life |
| A1 | LiCoO₂ | 0.03 | 3.19 | 3.22 | Robomics | 100 |
| A3 | LiCoO₂ | 0.03 | 3.19 | 3.22 | Bead mill | 126 |
| A4 | LiCoO₂ | 0.03 | 0.21 | 0.24 | Bead mill | 76 |
| A5 | LiCoO₂ | 0.03 | 0.43 | 0.46 | Bead mill | 88 |
| A6 | LiCoO₂ | 0.03 | 4.79 | 4.82 | Bead mill | 129 |
| A7 | LiCoO₂ | 0.03 | 5.32 | 5.35 | Bead mill | 121 |
| A2 | LiNi_{0.4}Mn_{0.3}Co_{0.3}O₂ | 0.12 | 3.20 | 3.32 | Robomics | 117 |
| A8 | LiNi_{0.4}Mn_{0.3}Co_{0.3}O₂ | 0.12 | 3.20 | 3.32 | Bead mill | 139 |
| A9 | LiNi_{0.4}Mn_{0.3}Co_{0.3}O₂ | 0.12 | 0.21 | 0.33 | Bead mill | 83 |
| A10 | LiNi_{0.4}Mn_{0.3}Co_{0.3}O₂ | 0.12 | 0.43 | 0.55 | Robomics | 99 |
| A11 | LiNi_{0.4}Mn_{0.3}Co_{0.3}O₂ | 0.12 | 4.79 | 4.91 | Bead mill | 141 |
| A12 | LiNi_{0.4}Mn_{0.3}Co_{0.3}O₂ | 0.12 | 5.33 | 5.45 | Bead mill | 121 |
| A13 | Li_{1.02}Ni_{0.4}Mn_{0.3}Co_{0.3}O₂ | 0.19 | 3.20 | 3.39 | Bead mill | 118 |

Batteries A3 to A7 and A8 to A13 employ the positive electrode pastes in which lithium carbonate has been mixed and dispersed with the conductive agent uniformly in advance, so in Batteries A3 to A7 and A8 to A13, the lithium carbonate is mixed and dispersed more uniformly than in Batteries A1 and A2. When Batteries A3 and A8 are compared with Batteries A1 and A2, Batteries A3 and A8 have longer cycle life, which means that they are superior in charge-discharge cycle performance. Thus, it will be appreciated that cycle performance improves further when the lithium carbonate contained in the positive electrode is uniformly distributed around the positive electrode active material.

Moreover, when comparing Batteries A3 to A7 and A8 to A12 in terms of cycle life, it will be appreciated that Batteries A3 and A5 to A7 as well as Batteries A8 and A10 to A12 exhibit superior cycle performance to Batteries A4 and A9. This is believed to be because the effect of improving charge-discharge cycle performance due to the addition of lithium carbonate becomes more effective when the total amount of the lithium carbonate contained in the positive electrode is 0.4 weight % or greater of the positive electrode active material.

In addition, swelling of the batteries due to gas generation was observed in Batteries A7 and A12, in which the content of lithium carbonate exceeds 5 weight % of the positive electrode active material.

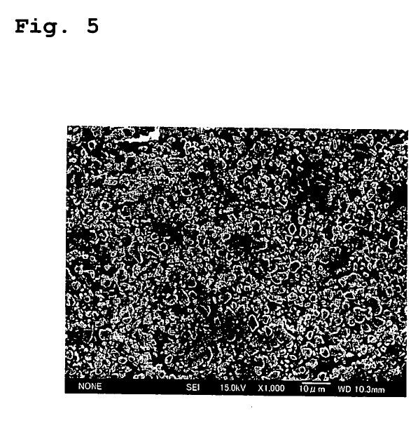

SEM Observation of Cross Section of the Positive Electrode The positive electrodes used in Batteries A1 and A3 were observed with a scanning electron microscope (SEM). FIG. 3 is a SEM micrograph showing a cross section of the positive electrode of Battery A1, and FIGS. 4 and 5 are SEM micrographs each showing a cross section of the positive electrode of Battery A3. The magnification of FIG. 3 is 700 times, the magnification of FIG. 4 is 200 times, and the magnification of FIG. 5 is 1000 times.

FIG. 3 clearly shows that in Battery A1, lithium carbonate powder exists in the mixture layer in an aggregated condition. It should be noted that lithium carbonate has a lower conductivity than the active material and carbon material contained in the mixture layer, and therefore appears whiter.

As seen from FIGS. 4 and 5, lithium carbonate particles having large particle sizes are not observed in Battery A3, which means that the positive electrode active material and the lithium carbonate powder exist in the mixture layer in a uniformly mixed condition.

Experiment 9

Batteries B7 and B8 were fabricated in the same manners as in Experiment 1 except that the same amount of, and one-tenth the amount of, lithium carbonate powder (average particle size 50 μm) contained in the positive electrode of Battery A1 were added in the negative electrode mixture slurry when preparing the negative electrodes, respectively, in place of adding lithium carbonate to the positive electrodes when preparing the positive electrodes.

Battery B9 was fabricated in the same manner as in Experiment 1 except that the same amount of lithium carbonate powder (average particle size 50 μm) as that contained in the positive electrode of Battery A1 was added in the electrolyte solution when preparing the electrolyte solution, in place of adding lithium carbonate when preparing the positive electrode.

Batteries B7 to B9 were evaluated in terms of the charge-discharge cycle performance in the same manner as described above. The results are shown in Table 3. Table 3 also shows the result for Battery A1.

TABLE 3

| Battery | Where Li₂CO₃ is added | Cycle life |
|---|---|---|
| A1 | Positive electrode | 100 |
| B7 | Negative electrode | 25 |
| B8 | Negative electrode | 49 |
| B9 | Electrolyte solution | 65 |

Table 3 clearly demonstrates that Batteries B7 to B9, in which lithium carbonate was not added in the positive electrodes, showed poorer charge-discharge cycle performance than Battery A1, in which lithium carbonate was added in the positive electrode. The reason is believed to be as follows. In Batteries B7 and B8, in which lithium carbonate was added in the negative electrodes, the potential of the negative electrodes were low; consequently, decomposition of lithium carbonate did not occur, and thus, the advantageous effect due to lithium carbonate, such as obtained in Battery A1, was not obtained.

In Battery B7, since the amount of lithium carbonate added in the negative electrode was greater than that in Battery B8, the contact area between the negative electrode active material and the negative electrode binder was smaller. Consequently, it is believed that the strength of the negative electrode mixture layer lowered and changes in volume of the negative electrode active material occurred during charging and discharging operations, causing the electrode structure to destruct and thus degrading the current collection performance. Thus, the charge-discharge cycle performance lowered more significantly.

Moreover, it is believed that in Battery B9, since lithium carbonate was added in the electrolyte solution, not all the lithium carbonate existing in the battery system worked effectively unlike the addition of lithium carbonate to the positive electrode; therefore, the charge-discharge cycle performance did not improve sufficiently.

Reference Experiment

Batteries employing natural graphite as the negative electrode active material were fabricated to study the influence of the lithium carbonate contained in the positive electrode in cases where the negative electrode active material is natural graphite.

Preparation of Negative Electrode

Natural graphite powder having an average particle size of 18 μm, which serves as a negative electrode active material, and polyvinylidene fluoride, which serves as a negative electrode binder, were mixed together with N-methyl-2-pyrrolidone as a dispersion medium so that the weight ratio of the active material to the binder became 90:10, to thus prepare a negative electrode mixture slurry.

The resultant negative electrode mixture slurry was applied onto one side of (a roughened surface of) an electrolytic copper foil (thickness 35 μm), which was a negative electrode current collector, and then dried. The resultant article was cut out into a 25 mm×30 mm rectangle shape and then pressure-rolled, to thus prepare a negative electrode C1.

Preparation of Batteries

Batteries C1 to C8 were fabricated in the same manners as in fabricating Batteries A1 and B1 to B3 as well as A2 and B4 to B6, respectively, except that the negative electrode C1 was used as the negative electrode in each of the batteries.

Evaluation of Charge-Discharge Cycle Performance

Batteries C1 to C8 fabricated as described above were evaluated in terms of the charge-discharge cycle performance. Each battery was charged at 25° C. to 4.2 V and thereafter discharged to 2.75 V. This process was taken as 1 charge-discharge cycle. The charge-discharge cycle was repeated to determine the number of cycles until the discharge capacity of each battery reached 80% of the discharge capacity at the first cycle, and the number of cycles thus obtained was taken as the cycle life of the battery. It should be noted that the cycle life values of Batteries C1 to C4 are indicated by relative indices wherein the cycle life of Battery C1 is taken as 100.

TABLE 4

| | | Lithium | Carbon | |
|---|---|---|---|---|
| | | carbonate | dioxide | |
| | Positive | added in | dissolved in | |
| | electrode | positive | electrolyte | Cycle |
| Battery | active material | electrode | solution | life |
| C1 | LiCoO₂ | Yes | Yes | 100 |
| C2 | LiCoO₂ | No | Yes | 101 |
| C3 | LiCoO₂ | Yes | No | 99 |
| C4 | LiCoO₂ | No | No | 97 |
| C5 | LiNi_{0.4}Mn_{0.3}Co_{0.3}O₂ | Yes | Yes | 93 |
| C6 | LiNi_{0.4}Mn_{0.3}Co_{0.3}O₂ | No | Yes | 91 |
| C7 | LiNi_{0.4}Mn_{0.3}Co_{0.3}O₂ | Yes | No | 92 |
| C8 | LiNi_{0.4}Mn_{0.3}Co_{0.3}O₂ | No | No | 90 |

The results shown in Table 4 clearly demonstrate that the advantageous effect attained by adding lithium carbonate in the positive electrode and dissolving carbon dioxide in the electrolyte solution is smaller in the case where natural graphite is used as the negative electrode than in the present invention, which utilizes Si for the negative electrode active material. This indicates that when a material containing silicon is used as the negative electrode active material, the advantageous effect of the present invention will be significant.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese Patent Application Nos. 2004-365390 and 2005-245895 filed Dec. 17, 2004, and Aug. 26, 2005, respectively, which are incorporated herein by reference.

What is claimed is:

1. A lithium secondary battery comprising:
a negative electrode containing silicon as a negative electrode active material;
a positive electrode containing a lithium-transition metal composite oxide as a positive electrode active material; and
a non-aqueous electrolyte, wherein
lithium carbonate is contained in the positive electrode, and carbon dioxide is dissolved in the non-aqueous electrolyte.

2. The lithium secondary battery according to claim 1, wherein the lithium carbonate in the positive electrode is uniformly mixed with the lithium-transition metal composite oxide.

3. The lithium secondary battery according to claim 1, wherein the amount of the lithium carbonate contained in the positive electrode is within the range of from 0.3 weight % to 5 weight % with respect to the lithium-transition metal composite oxide.

4. The lithium secondary battery according to claim 2, wherein the amount of the lithium carbonate contained in the positive electrode is within the range of from 0.3 weight % to 5 weight % with respect to the lithium-transition metal composite oxide.

5. The lithium secondary battery according to claim 1, wherein lithium carbonate is contained in the lithium-transition metal composite oxide and the total amount of the lithium carbonate contained in the lithium-transition metal composite oxide and the lithium carbonate separately contained in the positive electrode is within the range of from 0.3 weight % to 5 weight % with respect to the lithium-transition metal composite oxide.

6. The lithium secondary battery according to claim 2, wherein lithium carbonate is contained in the lithium-transition metal composite oxide and the total amount of the lithium carbonate contained in the lithium-transition metal composite oxide and the lithium carbonate separately contained in the positive electrode is within the range of from 0.3 weight % to 5 weight % with respect to the lithium-transition metal composite oxide.

7. The lithium secondary battery according to claim 5, wherein the lithium carbonate contained in the lithium-transition metal composite oxide exists in and near a surface of the lithium-transition metal composite oxide.

8. The lithium secondary battery according to claim 6, wherein the lithium carbonate contained in the lithium-transition metal composite oxide exists in and near a surface of the lithium-transition metal composite oxide.

9. The lithium secondary battery according to claim 1, wherein the positive electrode comprises a positive electrode current collector made of a conductive metal foil, and a mixture layer arranged on the positive electrode current collector and containing the positive electrode active material, the lithium carbonate, a positive electrode binder, and a positive electrode conductive agent.

10. The lithium secondary battery according to claim 2, wherein the positive electrode comprises a positive electrode current collector made of a conductive metal foil, and a mixture layer arranged on the positive electrode current collector and containing the positive electrode active material, the lithium carbonate, a positive electrode binder, and a positive electrode conductive agent.

11. The lithium secondary battery according to claim 1, wherein the negative electrode comprises a negative electrode current collector made of a conductive metal foil, and a mixture layer arranged on the negative electrode current collector and containing a binder and active material particles containing silicon and/or a silicon alloy.

12. The lithium secondary battery according to claim 2, wherein the negative electrode comprises a negative electrode current collector made of a conductive metal foil, and a mixture layer arranged on the negative electrode current collector and containing a binder and active material particles containing silicon and/or a silicon alloy.

13. The lithium secondary battery according to claim 11, wherein in the negative electrode, the mixture layer is sintered on a surface of the negative electrode current collector.

14. The lithium secondary battery according to claim 12, wherein in the negative electrode, the mixture layer is sintered on a surface of the negative electrode current collector.

15. The lithium secondary battery according to claim 1, wherein the amount of the carbon dioxide dissolved in the non-aqueous electrolyte is 0.01 weight % or greater.

16. The lithium secondary battery according to claim 2, wherein the amount of the carbon dioxide dissolved in the non-aqueous electrolyte is 0.01 weight % or greater.

17. The lithium secondary battery according to claim 3, wherein the amount of the carbon dioxide dissolved in the non-aqueous electrolyte is 0.01 weight % or greater.

18. The lithium secondary battery according to claim 4, wherein the amount of the carbon dioxide dissolved in the non-aqueous electrolyte is 0.01 weight % or greater.
